(19) United States
(12) Patent Application Publication
(10) Pub. No.: US 2005/0275877 A1
(43) Pub. Date: Dec. 15, 2005

(54) System and method for intelligent queuing of documents for processing thereof

(76) Inventors: Harpreet Singh, Orange, CA (US); Louis Ormond, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/866,412

(22) Filed: Jun. 12, 2004

(51) Int. Cl. G06F 13/00

(52) U.S. Cl. 358/1.15

(57) ABSTRACT

This invention is directed to a system and method for intelligent queuing of documents for processing thereof. More particularly, this invention is directed to a system and method for generating status information about selected networking document processing devices and transmitting such information to an associated user so that a user is able to select a suitably available network document processing device for processing operations.

### BACKGROUND OF THE INVENTION

This invention is directed to a system and method for intelligent queuing of documents for processing thereof. More particularly, this invention is directed to a system and method for intelligent queuing of document processing requests to document processing devices such that a user is able to select the document processing device that is not currently busy or is the least busy at the time of the request.

In a typical office computer network, multiple document processing devices or multifunctional peripherals are available to the users of the network for document processing operations, such as printing. Often large batch document processing jobs are sent to a particular document processing device and such print jobs keep that printer busy for an extended period of time. If another user sends another document processing job to the document processing device handling the large batch job, that job may be lost between the large batch jobs or the user has to wait until the batch job is completed for the user's job to be processed. In the event that the job is lost, the user must either resend the job to another document processing device or to another document processing device for processing, thus adding extra steps and processing time to complete the job. If the job is not lost, the user must wait for the completion of the large batch job before his job is processed, also added extra processing time to the job.

It is desirable to have a system and method for intelligent queuing of document processing requests to document processing devices such that a user is able to select the document processing device that is not currently busy or is the least busy at the time of the request thereby increasing the efficiency of processing the job and decreasing the processing time.

### SUMMARY OF THE INVENTION

In accordance with the present invention, there is provided a system and method for intelligent queuing of documents for processing thereof.

Further, in accordance with the present invention, there is provided a system and method for intelligent queuing of document processing requests to document processing devices such that a user is able to select the document processing device that is not currently busy or is the least busy at the time of the request.

Still further in accordance with the present invention, there is provided a system for intelligent queuing of documents for processing thereof. The system comprises means adapted for receiving status information from each of a plurality of associated networked document processing devices, which status information is representative of device availability associated which each associated networked document processing devices and means adapted for communicating the status information to at least one associated user interface. The system also comprises means adapted for receiving selection data from the at least one associated user interface, which selection data is representative of a selected one of the plurality of networked document processing devices and routing means adapted for routing electronic document data to the selected one of the plurality of networked document devices in accordance with the selection data.

In a preferred embodiment, the plurality of networked document processing devices include a plurality of printers, further comprising a print controller, the print controller including means adapted for relaying the status information between the printers and the user interface. In another embodiment, the status information includes data representative of at least one of number of print jobs pending, number of pages awaiting printing, job log information and device error information.

In one embodiment, the system actively periodically polls the network document processing devices for document processing queue data. In another embodiment, the system continuously monitors network document processing devices for queue data.

In one embodiment, the system further comprises means adapted for generating data representative of a graphical indication of the status information, such as a color indicating the business of the network document processing device.

Still further, in accordance with the present invention, there is provided a method for intelligent queuing of documents for processing thereof. The method comprises the steps of receiving status information from each of a plurality of associated networked document processing devices, which status information is representative of device availability associated which each associated networked document processing devices and communicating the status information to at least one associated user interface. The method further comprises the steps of receiving selection data from the at least one associated user interface, which selection data is representative of a selected one of the plurality of networked document processing devices and routing electronic document data to the selected one of the plurality of networked document devices in accordance with the selection data.

In a preferred embodiment, the plurality of networked document processing devices include a plurality of printers, further comprising a print controller, the print controller including means adapted for relaying the status information between the printers and the user interface. In another embodiment, the status information includes data representative of at least one of number of print jobs pending, number of pages awaiting printing, job log information and device error information.

In one embodiment, the network document processing devices are actively periodically polled for document processing queue data. In another embodiment, the network document processing devices are continuously monitored for queue data.

In one embodiment, the method further comprises the step of generating data representative of a graphical indication of the status information, such as a color indicating the business of the network document processing device.

These and other aspects, advantages, and features of the present invention will be understood by one of ordinary skill in the art upon reading and understanding the specification.

### BRIEF DESCRIPTION OF THE DRAWINGS

FIG. 1 is a block diagram of the system according to the present invention.

FIG. 2 is a flowchart illustrating the method according to the present invention.

FIG. 3 is a sample template for selecting which network document processing devices to show the status and the type of status information to be received.

FIG. 4 is a sample user displaying illustrating the status of selected network document processing devices.

### DETAILED DESCRIPTION OF THE PREFERRED EMBODIMENTS

This invention is directed to a system and method for intelligent queuing of documents for processing thereof. More particularly, this invention is directed to a system and method for generating status information about selected networking document processing devices and transmitting such information to an associated user so that a user is able to identify and select a suitably available or optimal network document processing device for processing operations.

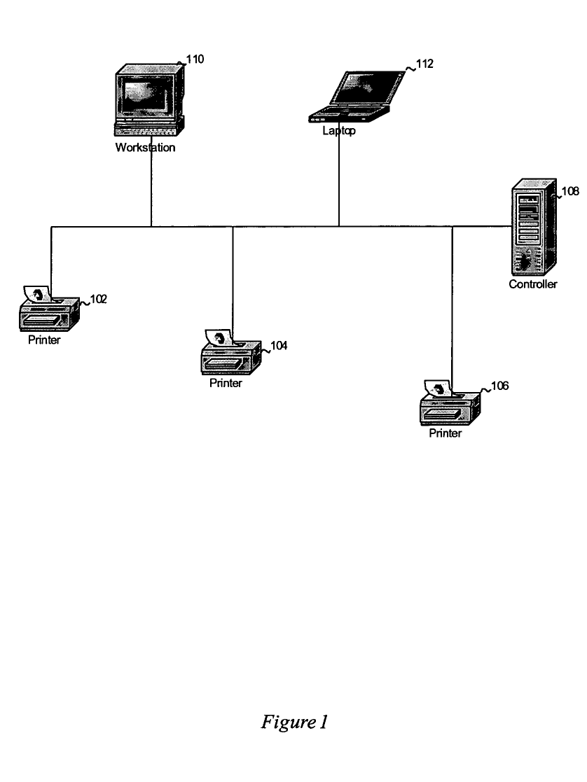

FIG. 1 shows a block diagram of a preferred embodiment of the system according to the present invention generally designated as 100. The system comprises a plurality of document processing devices, as illustrated by multi-function peripheral devices 102, 104, and 106, for generating or processing image data. It is to be appreciated that a document processing device is any suitable document processing device known in the art, such as a copier, printer, scanner, facsimile machine and the like, or any combination thereof. Suitable commercially available document reading devices include, but are not limited to, the Toshiba e-Studio Series Controller. The document processing devices further comprise a controller which controls the functions of the document processing device and receives and transmits status information of the document processing devices as will be appreciated by one of ordinary skill in the art. In one embodiment, there is one controller 108 as shown which controls the document processing operations for a selected set of processing devices, and as illustrated, includes all of the available document processing devices. In another embodiment, a controller is associated or located within each document processing device for controlling the document processing operations of each document processing device and receiving and transmitting status information for the device. Preferably, the plurality of document processing devices include a plurality of printers and a print controller for relaying status information.

The system also includes at least one user workstation or network computer in data communication with the document processing devices and controller. As shown in FIG. 1, the system includes a workstation 110 and a network computer 112 in data communication with the document processing devices and the controller. The user workstation or network computer includes a display means, such as a monitor, for displaying the status information to the user. The user workstation or the network computer also includes a user interface by which the user accesses the status information and selects the desired document processing device for processing operations based on the status information. It will be appreciated that viable user interfaces may take various forms, such as touch screen, keypads, pen input, and the like.

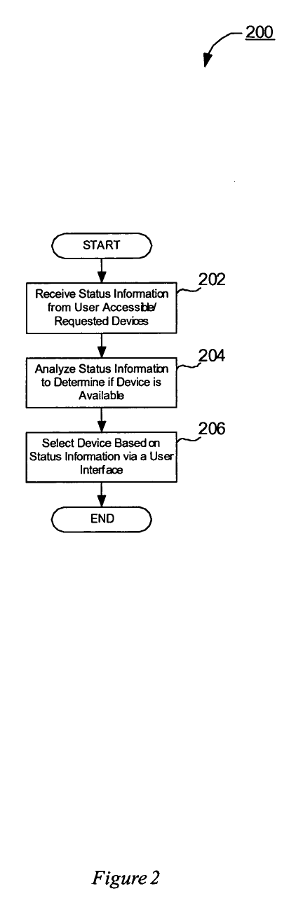

FIG. 2 is a flowchart 200 illustrating the method according to the present invention. At 202, the system receives status information from the document processing devices for which the user has access or the ability to request processing operations. In one embodiment, status information is received for those document processing devices to which the user has access or has the appropriate drivers to request processing.

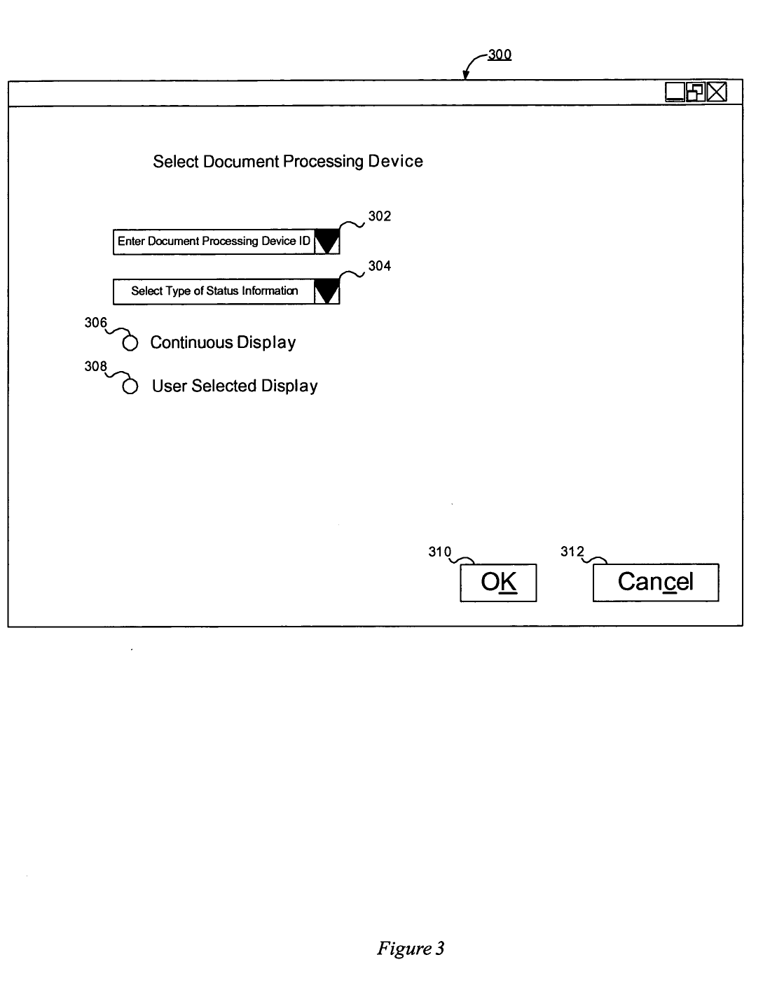

In another embodiment, the user selects those document processing devices for which the user desires status information. FIG. 3 shows a sample template 300 for selecting the document processing devices for which the user desires status information. At 302, the user enters the identification of the document processing devices for which the user desires status information by any suitable user interface means, such as a keyboard, touch screen, cursor placement, and the like.

The system receives the status information about the document processing devices via any suitable means. In one embodiment, the system periodically actively polls the document processing devices for status information and receives document processing queue information via any suitable means. In another embodiment, the system continuously monitors the document process devices for document processing queue information via any suitable means. The status information received includes, but is not limited to, the number ofjobs pending on the document processing device, the number of pages pending, the job log information, and any device error information.

At 204, the status information for each document processing device is analyzed by any suitable means (Any preferred process for analyzing the information?) and the availability of each document processing device is determined via any suitable means (any information?). The calculation preferably uses the number of jobs and number of pages to calculate an availability time. This calculation is checked against the job history of the device via any suitable means to determine if there are recurring events that make it a less than optimal choice, such as batch jobs starting at a certain time daily, regularity of receiving large jobs, regularity of errors, and if the device is not currently in service.

The availability of each document processing device to which the user has access, the ability to request processing operations, or selected by the user is transmitted to the workstation or network computer accessed by the user via any suitable means. In a preferred environment, the computers are networked for data interchange via any suitable networking schemes, including wireless or wired, and using various networking data protocols as will be appreciated by one of ordinary skill in the art, In a preferred embodiment, the status information is received from the document processing devices to the controller, wherein the status information is analyzed and then transmitted to the workstation or network computer. Preferably, the status information is transmitted via SNMP, XML, or other suitable protocol.

The status information is displayed on the display means of the workstation or network computer and provides the user with availability to the selected document processing devices. Preferably, the display of the status information is a graphical representation of the status information for each document processing device. In a more preferred embodiment, the status information for each document processing device is shown in a selected color indicating the status. For example, if the status information is a red color, that particular device is busy. If the status information is a yellow color, that particular device is busy but will be available. If the status information is a green color, that particular device is available. FIG. 4 shows a sample screen 400 showing the status of selected document processing devices. (Please provide sample screen)

In a preferred embodiment, the status information for each document processing device to be received by the user is selected by the user via any suitable means. FIG. 3 shows a sample template 300 for selecting the type of information to be received. At 304, the user specifies the type of information to be received for each device via any suitable means. In addition, the user is able to select the option to have the information displayed at all times or as needed by selecting the appropriate option at 306 and 308. Once the user has specified the information for the device 304, and selected the appropriate option 306 and 308, the user may then desire to continue the operation by selecting the “OK” button 310. In the event that the user has made an error, or determined that proceeding with the operation is no longer desired, the user may end the operation by selecting the “Cancel” button 312 of template 300. (Please provide sample template)

At 206, the user selects the appropriate document processing device for the processing job based on the status information via the user interface via any suitable means. (Any information as to how to select?). Once the user has selected the document processing device for the processing job, the job is routed to the selected device via any suitable means for processing.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

1. A system for intelligent queuing of documents for processing thereof comprising:
means adapted for receiving status information from each of a plurality of associated networked document processing devices, which status information is representative of device availability associated which each associated networked document processing devices;
means adapted for communicating the status information to at least one associated user interface;
means adapted for receiving selection data from the at least one associated user interface, which selection data is representative of a selected one of the plurality of networked document processing devices; and
routing means adapted for routing electronic document data to the selected one of the plurality of networked document devices in accordance with the selection data.

2. The system for intelligent queuing of documents for processing of claim 1 wherein the plurality of networked document processing devices includes a plurality of printers, further comprising a print controller, the print controller including means adapted for relaying the status information between the printers and the user interface.

3. The system for intelligent queuing of documents for processing of claim 2 wherein the status information includes data representative of at least one of number of print jobs pending, number of pages awaiting printing, job log information and device error information.

4. The system for intelligent queuing of documents for processing of claim 1 further comprising means adapted for periodically polling each of the plurality of associated networked document processing devices to secure a transfer of the status information.

5. The system for intelligent queuing of documents for processing of claim 1 further comprising means adapted for continuously monitoring each of the plurality of associated networked document processing devices broadcast data to receive the status information from each of the associated network document processing devices.

6. The system for intelligent queuing of documents for processing of claim 1 further comprising means for generating data representative of a graphical indication of the status information.

7. The system for intelligent queuing of documents for processing of claim 6 wherein the graphical indication of the status information includes displaying at least one color for at least one device wherein the color is representative of the status of the device.

8. The system for intelligent queuing of documents for processing of claim 1 further comprising means adapted for receiving status selection data from the at least one associated user interface, wherein the status selection data is representative of at least one of from which of the associated network document processing devices status information is to be communicated to the at least one associated user interface and type of status information is to be communicated to the at least one associated user interface.

9. A method for intelligent queuing of documents for processing thereof comprising the steps of:
receiving status information from each of a plurality of associated networked document processing devices, which status information is representative of device availability associated which each associated networked document processing devices;
communicating the status information to at least one associated user interface;
receiving selection data from the at least one associated user interface, which selection data is representative of a selected one of the plurality of networked document processing devices; and
routing electronic document data to the selected one of the plurality of networked document devices in accordance with the selection data.

10. The method for intelligent queuing of documents for processing of claim 9 wherein the plurality of networked document processing devices includes a plurality of printers, further comprising a print controller, the print controller including means adapted for relaying the status information between the printers and the user interface.

11. The method for intelligent queuing of documents for processing of claim 10 wherein the status information includes data representative of at least one of number of print jobs pending, number of pages awaiting printing, job log information and device error information.

12. The method for intelligent queuing of documents for processing of claim 9 further comprising the step of periodically polling each of the plurality of associated networked document processing devices to secure a transfer of the status information.

13. The method for intelligent queuing of documents for processing of claim 9 further comprising the step of continuously monitoring each of the plurality of associated networked document processing devices broadcast data to receive the status information from each of the associated network document processing devices.

14. The method for intelligent queuing of documents for processing of claim 9 further comprising the step of generating data representative of a graphical indication of the status information.

15. The method for intelligent queuing of documents for processing of claim 14 wherein the graphical indication of the status information includes displaying at least one color for at least one device wherein the color is representative of the status of the device.

16. The method for intelligent queuing of documents for processing of claim 9 further comprising the step of receiving status selection data from the at least one associated user interface, wherein the status selection data is representative of at least one of from which of the associated network document processing devices status information is to be communicated to the at least one associated user interface and type of status information is to be communicated to the at least one associated user interface.

17. A computer-readable medium for intelligent queuing of documents for processing thereof comprising:
means adapted for receiving status information from each of a plurality of associated networked document processing devices, which status information is representative of device availability associated which each associated networked document processing devices;
means adapted for communicating the status information to at least one associated user interface;
means adapted for receiving selection data from the at least one associated user interface, which selection data is representative of a selected one of the plurality of networked document processing devices; and
routing means adapted for routing electronic document data to the selected one of the plurality of networked document devices in accordance with the selection data.

18. The computer-readable medium for intelligent queuing of documents for processing of claim 17 wherein the plurality of networked document processing devices includes a plurality of printers, further comprising a print controller, the print controller including means adapted for relaying the status information between the printers and the user interface.

19. The computer-readable for intelligent queuing of documents for processing of claim 18 wherein the status information includes data representative of at least one of number of print jobs pending, number of pages awaiting printing, job log information and device error information.

20. The computer-readable medium for intelligent queuing of documents for processing of claim 17 further comprising means adapted for periodically polling each of the plurality of associated networked document processing devices to secure a transfer of the status information.

21. The computer-readable medium for intelligent queuing of documents for processing of claim 17 further comprising means adapted for continuously monitoring each of the plurality of associated networked document processing devices broadcast data to receive the status information from each of the associated network document processing devices.

22. The computer-readable medium for intelligent queuing of documents for processing of claim 17 further comprising means for generating data representative of a graphical indication of the status information.

23. A computer-implemented method for intelligent queuing of documents for processing thereof comprising the steps of:
receiving status information from each of a plurality of associated networked document processing devices, which status information is representative of device availability associated which each associated networked document processing devices;
communicating the status information to at least one associated user interface;
receiving selection data from the at least one associated user interface, which selection data is representative of a selected one of the plurality of networked document processing devices; and
routing electronic document data to the selected one of the plurality of networked document devices in accordance with the selection data.

24. The computer-implemented method for intelligent queuing of documents for processing of claim 23 wherein the plurality of networked document processing devices includes a plurality of printers, further comprising a print controller, the print controller including means adapted for relaying the status information between the printers and the user interface.

25. The computer-implemented method for intelligent queuing of documents for processing of claim 24 wherein the status information includes data representative of at least one of number of print jobs pending, number of pages awaiting printing, job log information and device error information.

26. The computer-implemented method for intelligent queuing of documents for processing of claim 23 further comprising the step of periodically polling each of the plurality of associated networked document processing devices to secure a transfer of the status information.

27. The computer-implemented method for intelligent queuing of documents for processing of claim 23 further comprising the step of continuously monitoring each of the plurality of associated networked document processing devices broadcast data to receive the status information from each of the associated network document processing devices.

28. The computer-implemented method for intelligent queuing of documents for processing of claim 23 further comprising the step of generating data representative of a graphical indication of the status information.
